(19) United States
(12) Patent Application Publication
(10) Pub. No.: US 2026/0312104 A1
(43) Pub. Date: Oct. 8, 2026

(54) CO2 CAPTURE AND HYDROGEN RECOVERY FROM FUEL CELL ANODE OFF GAS

(71) Applicant: UOP LLC, Des Plaines, IL (US)

(72) Inventor: Bradley Russell, Longmont, CO (US)

(21) Appl. No.: 19/420,994

(22) Filed: Dec. 16, 2025

Related U.S. Application Data
(60) Provisional application No. 63/783,277, filed on Apr. 4, 2025.

(51) Int. Cl. H01M 8/0668; B01D 53/047; B01D 53/26; B01D 53/62; B01D 53/75; B01D 53/76; H01M 8/04089; H01M 8/12; H01M 8/14

(52) U.S. Cl. CPC H01M 8/0668; B01D 53/047; B01D 53/26; B01D 53/62; B01D 53/75; B01D 53/76; H01M 8/04097; B01D 2251/102; B01D 2256/16; B01D 2256/22; B01D 2257/504; B01D 2257/80; B01D 2258/0208; H01M 2008/1293; H01M 2008/147

(57) ABSTRACT

Processes for CO₂ capture in fuel cell applications are described. The processes involve the use of pressure swing adsorption (PSA) technology for CO₂ capture. The residue gas from the CO₂ PSA, which comprises hydrogen, carbon monoxide, methane, and small amounts of nitrogen, can be recycled to the anode. Alternatively, hydrogen can be recovered directly from the residue gas using an H₂ PSA unit, and recycling the H₂ PSA tail gas, which comprises an enriched CO/methane stream, to the anode.

### RELATED APPLICATIONS

This application claims priority to U.S. Provisional Patent Application Ser. No. 63/783,277 filed on Apr. 4, 2025, the entirety of which is incorporated herein by reference.

### BACKGROUND

Solid oxide and carbonate fuel cells are an emerging technology for electricity generation from traditional hydrocarbon fuels, such as natural gas. These types of fuel cells incorporate internal steam reforming and water-gas shift on the anode side to convert the fuel gas to hydrogen and carbon monoxide/carbon dioxide. Hydrogen reacts with carbonate ions (carbonate fuel cell) or oxygen ions (solid oxide fuel cell) to form water vapor and electricity. The anode exhaust gas comprises significant quantities of carbon dioxide, as well as byproduct hydrogen, carbon monoxide, and residual methane.

Therefore, there is a need for improved processes for CO₂ capture in fuel cell applications.

In addition, opportunities exist for recovery of byproduct hydrogen for external use and selective recycle of carbon monoxide and methane to the anode for improved efficiency.

### BRIEF DESCRIPTION OF THE DRAWINGS

FIG. 1 is an illustration of one embodiment of a process for CO₂ capture from a fuel cell off gas stream according to the present invention.

FIG. 2 is an illustration another one embodiment of a process for CO₂ capture from a fuel cell off gas stream according to the present invention.

### DESCRIPTION

The present invention involves processes for CO₂ capture from a fuel cell anode off gas stream. Carbon emissions from the fuel cell are reduced when CO₂ is captured from the anode exhaust gas and geologically sequestered or utilized, thereby enabling clean electricity generation. The anode off gas stream is much more concentrated in CO₂ (e.g., about 45 to 65 mol %, dry basis) compared to conventional gas turbine exhaust (e.g., about 5 mol %, dry basis). As a result, the cost of CO₂ capture is reduced compared to flue gas CO₂ capture on gas turbine power plants.

New processes for CO₂ capture in fuel cell applications have been developed. The processes involve the use of pressure swing adsorption (PSA) technology for CO₂ capture, as well as hydrogen recovery. It may also include CO and methane recycle to the anode of the fuel cell. In general, it has been found that the CO₂ PSA is the most economical option for CO₂ capture based on typical CO₂ pipeline specifications. The residue gas from the CO₂ PSA, which comprises hydrogen, carbon monoxide, methane, and small amounts of nitrogen, can be recycled to the anode. Alternatively, hydrogen can be recovered directly from the residue gas using an H₂ PSA unit, and recycling the H₂ PSA tail gas, which comprises an enriched CO/methane stream, to the anode. It is believed that these PSA based flow schemes are generally more economical than alternative CO₂ capture methods based on solvents or cryogenic systems.

Another key feature of some embodiments of the PSA process is that selective purging of nitrogen to a carbon-free fuel gas stream can be accomplished using a 3-product H₂ PSA system on the residue gas, thereby reducing carbon emissions from the integrated system.

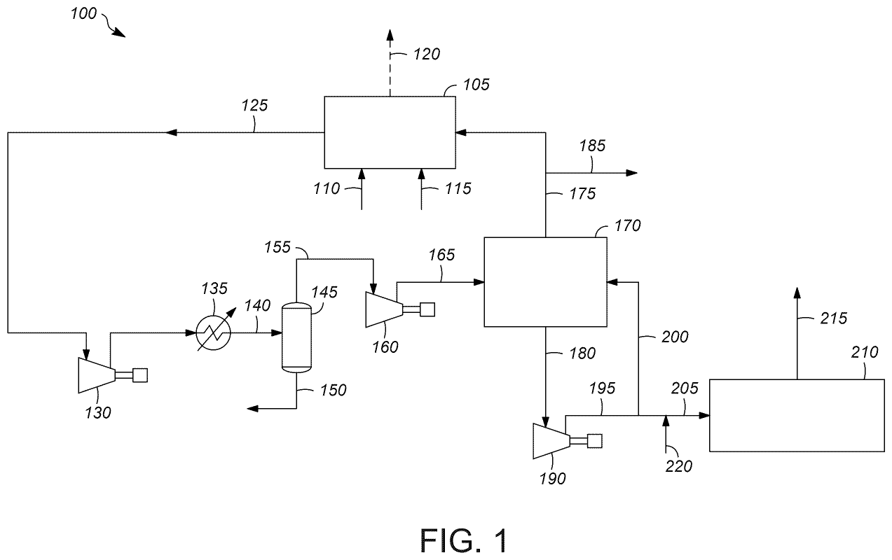

One embodiment of a process 100 is shown in FIG. 1.

The fuel cell 105 comprises an anode, a cathode, and an electrolyte. The fuel cell 105 can be a solid oxide fuel cell or a carbonate fuel cell (also known as a molten carbonate fuel cell).

The anode feed gas stream 110 to the fuel cell can be a hydrocarbon stream, such as natural gas and liquefied petroleum gas (LPG), and steam. Other gas feed streams, such as a hydrogen gas stream, a hydrogen-rich gas stream, a synthesis gas stream (hydrogen and CO) with or without hydrocarbons can also be used, either as an alternative feed stream or as a supplement.

The cathode feed gas stream 115 to a solid oxide fuel cell can be an oxygen-containing stream, such as air. The cathode feed gas stream 115 to a carbonate fuel cell can be any gas stream containing oxygen and CO₂. It could be mixed with other streams containing CO₂, flue gas from an industrial process, and the like.

The fuel cell 105 produces electricity 120 and an anode off gas stream 125. The anode off gas stream 125 comprises CO₂ and at least one of hydrogen, CO, methane, water, and nitrogen and has a pressure in the range of 100 to 180 kPa.

The electricity 120 can be used to drive a compressor, another piece of process equipment in the process, a piece of equipment in a different process, or it can be exported to an electrical grid, or combinations thereof.

The anode off gas stream 125 is sent through a blower 130 to a cooler 135 where the anode off gas stream 125 is cooled.

The cooled anode off gas stream 140 is sent to a knockout drum 145 where water stream 150 is removed. The dewatered anode off gas stream 155 is compressed in PSA feed compressor 160.

The compressed cooled anode off gas stream 165 is sent to the CO₂ PSA unit 170 where it is separated into a residue stream 175 and a tail gas stream 180. The residue stream 175 comprises hydrogen, CO, methane, and, in some cases, nitrogen. A portion 185 of the residue stream 175 can be removed and used as fuel gas to reduce the nitrogen in the system. The remainder of the residue stream 175 can be sent to the anode of the fuel cell 105.

The tail gas stream 180 from the CO₂ PSA unit 170 comprises CO₂. The tail gas stream 180 is compressed in compressor 190. The compressed tail gas stream 195 can be divided into a first portion 200 and a second portion 205. The first portion 200 of the compressed tail gas stream 195 is recycled to the CO₂ PSA unit 170. The second portion 205 is sent to a CO₂ compression and dehydration unit 210 to produce the CO₂ product stream 215.

In some embodiments, an oxygen-containing stream 220 may be added to the compressed tail gas stream 195 or the second portion 205 of the compressed tail gas stream 195. The oxygen stream 220 can be any suitable oxygen-containing stream, such as air, or another oxygen-containing stream, or pure oxygen. The mixed stream may be sent to a selective oxidation reactor (not shown) to convert CO to CO₂, which may be necessary to meet the CO limit on pipeline CO₂ (e.g., less than 1000 ppmv).

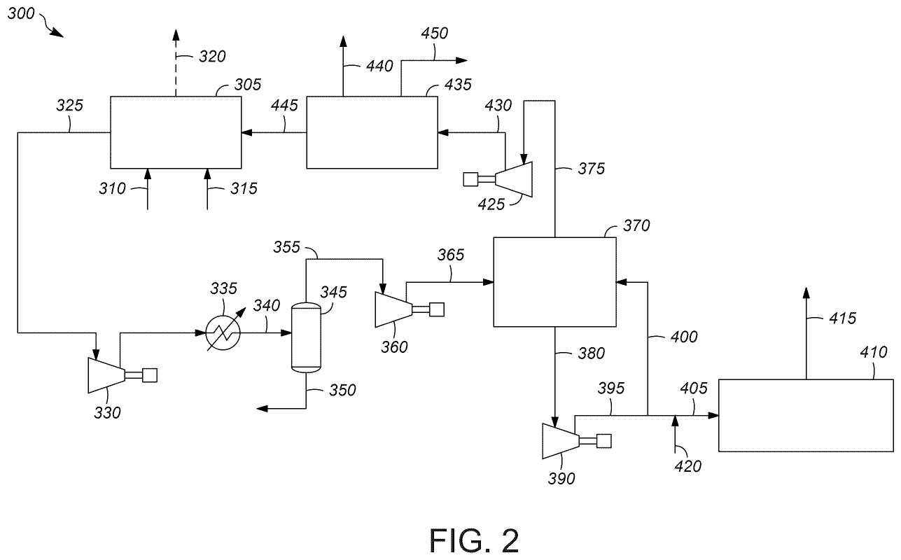

Another embodiment of a process 300 is shown in FIG. 2.

The fuel cell 305 comprises an anode, a cathode, and an electrolyte. The fuel cell 305 can be a solid oxide fuel cell or a carbonate fuel cell (also known as a molten carbonate fuel cell).

The anode feed gas stream 310 to the fuel cell can be a hydrocarbon stream, such as natural gas or LPG, and steam. Other gas feed streams, such as a hydrogen gas stream, a hydrogen-rich gas stream, a synthesis gas stream (hydrogen and CO) with or without hydrocarbons can also be used, either as an alternative feed stream or as a supplement

The cathode feed gas stream 315 to a solid oxide fuel cell can be an oxygen-containing stream, such as air. The cathode feed gas stream 315 to a carbonate fuel cell can be any gas stream containing oxygen and CO₂. It could be mixed with other streams containing CO₂, flue gas from an industrial process, and the like.

The fuel cell 305 produces electricity 320 and an anode off gas stream 325. The anode off gas stream 325 comprises CO₂ and at least one of hydrogen, CO, methane, water, and nitrogen and has a pressure in the range of 100 to 180 kPa.

The electricity 320 can be used to drive a compressor, another piece of process equipment in the process, a piece of equipment in a different process, or it can be exported to an electrical grid, or combinations thereof.

The anode off gas stream 325 is sent through a blower 330 to a cooler 335 where the anode off gas stream 325 is cooled.

The cooled anode off gas stream 340 is sent to a knockout drum 345 where water stream 350 is removed. The dewatered anode off gas stream 355 is compressed in PSA feed compressor 360.

The compressed cooled anode off gas stream 365 is sent to the CO₂ PSA unit 370 where it is separated into a residue stream 375 and a tail gas stream 380. The residue stream 375 comprises hydrogen, CO, methane, and, in some cases, nitrogen.

The tail gas stream 380 from the CO₂ PSA unit 370 comprises CO₂. The tail gas stream 380 is compressed in compressor 390. The compressed tail gas stream 395 can be divided into a first portion 400 and a second portion 405. The first portion 400 of the compressed tail gas stream 395 is recycled to the CO₂ PSA unit 370. The second portion 405 is sent to a CO₂ compression and dehydration unit 410 to produce the CO₂ product stream 415.

In some embodiments, an oxygen stream 420 may be added to the compressed tail gas stream 395 or the second portion 405 of the compressed tail gas stream 395. The oxygen stream 420 can be an oxygen-containing stream, such as air, or a more concentrated oxygen stream. The mixed stream may be sent to a selective oxidation reactor (not shown) to convert CO to CO₂, which may be necessary to meet the CO limit on pipeline CO₂ (e.g., less than 1000 ppmv).

The residue stream 375 is sent to a second PSA compressor 425. The compressed residue stream 430 is sent to an H₂ PSA system 435. The H₂ PSA system 435 produces a high pressure, high purity H₂ stream 440 comprising high purity hydrogen, a second tail gas stream 445 comprising CO and methane, with some hydrogen. The high pressure, high purity H₂ stream 440 can be recovered. The second tail gas stream 445 is sent to the anode of the fuel cell 305.

In some embodiments, there can be a vent gas stream 450 comprising nitrogen and a portion of the hydrogen. The vent gas stream can be burned as a carbon-free fuel gas reducing carbon emissions and reducing the nitrogen buildup in the process.

If the optional vent gas stream is present, the H₂ PSA system 435 can be a single three-product PSA unit or two two-product units, as described in U.S. Pat. Nos. 12,036,505, and 11,814,287, each of which is incorporated by reference herein in its entirety. If only two streams are produced in the H₂ PSA system 435, it can be a typical two product H₂ PSA unit.

### EXAMPLE

Carbon dioxide and hydrogen are recovered from carbonate fuel cell anode exhaust according to the process shown in FIG. 2. Stream properties below (flows, pressures, temperatures, and compositions) are based on computer simulations of the process. Carbon dioxide recovered in product stream 415 is sent to a high-pressure pipeline for geological sequestration. High-purity hydrogen recovered in stream 440 is used as chemical-grade feedstock in an adjacent refinery process. Fuel gas recovered in stream 450 is used in an adjacent refinery process (combusted in a fired heater) for process heating; this fuel gas stream is produced in a 3-product H₂ PSA unit and provides a means for purging nitrogen from the system (which enters the process from natural gas feed to the anode) without producing significant carbon emissions. Residue gas stream 445 comprises tail gas from the H₂ PSA unit and is recycled to the fuel cell anode; this stream is enriched in the anode reactants carbon monoxide and methane. Approximately 99% of the carbon monoxide and 98% of the methane in the anode exhaust feed stream 325 is recovered in the anode recycle stream 445.

Stream 325, Anode Exhaust Gas

| | |
|---|---|
| Pressure, kPa | 102 |
| Temperature, ° C. | 125 |
| Flow, kgmol / hr | 3912 |
| Composition, mol % | |
| CO₂ | 37.585 |
| Hydrogen | 21.755 |
| Carbon Monoxide | 5.202 |
| Methane | 0.946 |
| Water | 33.105 |
| N₂ | 1.408 |

Stream 365, CO₂ PSA Feed

| | |
|---|---|
| Pressure, kPa | 1273 |
| Temperature, ° C. | 40 |
| Flow, kgmol / hr | 2634 |
| Composition, mol % | |
| CO₂ | 55.800 |
| Hydrogen | 32.305 |
| Carbon Monoxide | 7.721 |
| Methane | 1.405 |
| Water | 0.678 |
| N₂ | 2.091 |

Stream 405, CO₂ PSA Product

| | |
|---|---|
| Pressure, kPa | 1273 |
| Temperature, ° C. | 40 |
| Flow, kgmol / hr | 1305 |
| Composition, mol % | |
| CO₂ | 99.179 |
| Hydrogen | 204 ppmv |
| Carbon Monoxide | 590 ppmv |
| Methane | 470 ppmv |
| Water | 0.691 |
| N₂ | 53 ppmv |

Stream 415, CO₂ Pipeline Product

| | |
|---|---|
| Pressure, kPa | 15,270 |
| Temperature, ° C. | 40 |
| Flow, kgmol / hr | 1296 |
| Composition, mol % | |
| CO₂ | 99.855 |
| Hydrogen | 205 ppmv |
| Carbon Monoxide | 590 ppmv |
| Methane | 470 ppmv |
| Water | 140 ppmv |
| N₂ | 53 ppmv |

Stream 440, H₂ Product

| | |
|---|---|
| Pressure, kPa | 2310 |
| Temperature, ° C. | 45 |
| Flow, kgmol / hr | 642.8 |
| Composition, mol % | |
| CO₂ | <1 ppmv |
| Hydrogen | 99.914 |
| Carbon Monoxide | <10 ppmv |
| Methane | <1 ppmv |
| Water | <1 ppmv |
| N₂ | 860 ppmv |

Stream 445, Anode Recycle Gas

| | |
|---|---|
| Pressure, kPa | 150 |
| Temperature, ° C. | 34 |
| Flow, kgmol / hr | 557.0 |
| Composition, mol % | |
| CO₂ | 31.463 |
| Hydrogen | 19.093 |
| Carbon Monoxide | 36.342 |
| Methane | 6.534 |
| Water | 0.000 |
| N₂ | 6.569 |

Stream 450, Fuel Gas

| | |
|---|---|
| Pressure, kPa | 377 |
| Temperature, ° C. | 45 |
| Flow, kgmol / hr | 120.2 |
| Composition, mol % | |
| CO₂ | 0.000 |
| Hydrogen | 84.952 |
| Carbon Monoxide | 0.169 |
| Methane | 0.000 |
| Water | 0.000 |
| N₂ | 14.880 |

### SPECIFIC EMBODIMENTS

While the following is described in conjunction with specific embodiments, it will be understood that this description is intended to illustrate and not limit the scope of the preceding description and the appended claims.

A first embodiment of the invention is a process for CO₂ capture from a fuel cell off gas stream comprising introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon, and the cathode feed stream comprises oxygen, or oxygen and CO₂, the fuel cell generating electricity and producing an anode off gas stream comprising CO₂ and one or more of hydrogen, CO, methane, water, and nitrogen; cooling the anode off gas stream; compressing the cooled anode off gas stream in a compressor to form a compressed cooled anode off gas stream; separating the compressed cooled anode off gas stream in a CO₂ pressure swing adsorption (PSA) system into a residue gas stream comprising CO, hydrogen, and methane and a tail gas stream comprising CO₂; introducing at least a portion of the CO, the hydrogen, and the methane from the residue gas stream into the anode; recovering CO₂ from the tail gas stream as a CO₂ product stream. An embodiment of the invention is one, any or all of prior embodiments in this paragraph up through the first embodiment in this paragraph wherein the residue gas stream further comprises nitrogen, and further comprising separating the residue gas stream in a second PSA system into a high pressure hydrogen stream comprising the hydrogen, a second tail gas stream comprising the CO, the methane, and a portion of the hydrogen, and optionally a vent gas stream comprising the nitrogen and a portion of the hydrogen; and wherein introducing at least the portion of the CO, the hydrogen, and the methane from the residue gas stream into the anode comprises introducing the second tail gas stream into the anode. An embodiment of the invention is one, any or all of prior embodiments in this paragraph up through the first embodiment in this paragraph wherein the vent gas stream is combusted. An embodiment of the invention is one, any or all of prior embodiments in this paragraph up through the first embodiment in this paragraph wherein at least the portion of the residue gas stream is directly introduced into the anode. An embodiment of the invention is one, any or all of prior embodiments in this paragraph up through the first embodiment in this paragraph further comprising dividing the residue gas into a first portion and a second portion; and combusting the first portion of the residue gas stream; and wherein introducing at least the portion of the CO, the hydrogen, and the methane from the residue gas stream into the anode comprises introducing the second portion of the residue gas stream into the anode. An embodiment of the invention is one, any or all of prior embodiments in this paragraph up through the first embodiment in this paragraph further comprising compressing the tail gas stream forming a compressed tail gas stream; dividing the compressed tail gas stream into a first portion and a second portion; recycling the first portion of the compressed tail gas stream to the CO₂ PSA system; and recovering the CO₂ from the tail gas stream comprises recovering the CO₂ from the second portion of the compressed tail gas stream. An embodiment of the invention is one, any or all of prior embodiments in this paragraph up through the first embodiment in this paragraph further comprising passing the second portion of the compressed tail gas stream to a compression and dehydration unit to form the CO₂ product stream. An embodiment of the invention is one, any or all of prior embodiments in this paragraph up through the first embodiment in this paragraph further comprising injecting oxygen into the second portion of the compressed tail gas stream to form a mixed stream; and passing the mixed stream to a selective oxidation reactor to convert CO to CO₂ before recovering the CO₂ from the tail gas stream. An embodiment of the invention is one, any or all of prior embodiments in this paragraph up through the first embodiment in this paragraph wherein the electricity is used to drive the compressor, or another piece of process equipment in the process, or a piece of equipment in a second process, or is exported to an electrical grid, or combinations thereof. An embodiment of the invention is one, any or all of prior embodiments in this paragraph up through the first embodiment in this paragraph wherein the fuel cell comprises a solid oxide fuel cell or a carbonate fuel cell or both. An embodiment of the invention is one, any or all of prior embodiments in this paragraph up through the first embodiment in this paragraph wherein the anode feed gas stream comprises natural gas. An embodiment of the invention is one, any or all of prior embodiments in this paragraph up through the first embodiment in this paragraph further comprising mixing a portion of a process gas stream with the anode off gas stream, or the cooled anode off gas stream, or the compressed cooled anode gas stream, or combinations thereof. An embodiment of the invention is one, any or all of prior embodiments in this paragraph up through the first embodiment in this paragraph wherein the anode off gas stream has a pressure in a range of 100 to 180 kPa. An embodiment of the invention is one, any or all of prior embodiments in this paragraph up through the first embodiment in this paragraph wherein the CO₂ product stream has a purity greater than or equal to 95 mol %. An embodiment of the invention is one, any or all of prior embodiments in this paragraph up through the first embodiment in this paragraph wherein the anode off gas stream (on a dry basis) comprises 15 to 45 mol % hydrogen, or 45 to 65 mol % CO₂, or 5 to 15 mol % CO, or combinations thereof.

A second embodiment of the invention is a process for CO₂ capture from a fuel cell off gas stream comprising introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon, and the cathode feed stream comprises oxygen, or oxygen and CO₂, the fuel cell generating electricity and producing an anode off gas stream comprising CO₂ and one or more of hydrogen, CO, methane, water, and nitrogen, wherein fuel cell comprises a solid oxide fuel cell or a carbonate fuel cell or both; cooling the anode off gas stream; compressing the cooled anode off gas stream in a compressor to form a compressed cooled anode off gas stream; separating the compressed cooled anode off gas stream in a CO₂ pressure swing adsorption (PSA) system into a residue gas stream comprising CO, hydrogen, and methane and a tail gas stream comprising CO₂; introducing at least a portion of the CO, the hydrogen, and the methane from the residue gas stream into the anode; compressing the tail gas stream forming a compressed tail gas stream; dividing the compressed tail gas stream into a first portion and a second portion; recycling the first portion of the compressed tail gas stream to the CO₂ PSA system; and recovering the CO₂ from the second portion of the compressed tail gas stream. An embodiment of the invention is one, any or all of prior embodiments in this paragraph up through the second embodiment in this paragraph wherein the residue gas stream further comprises nitrogen, and further comprising separating the residue gas stream in a second PSA system into a high pressure hydrogen stream comprising the hydrogen, a second tail gas stream comprising the CO, the methane, and a portion of the hydrogen, and optionally a vent gas stream comprising the nitrogen and a portion of the hydrogen; and wherein introducing at least the portion of the CO, the hydrogen, and the methane from the residue gas stream into the anode comprises introducing the second tail gas stream into the anode. An embodiment of the invention is one, any or all of prior embodiments in this paragraph up through the second embodiment in this paragraph further comprising dividing the residue gas into a first portion and a second portion; and combusting the first portion of the residue gas stream; and wherein introducing at least the portion of the CO, the hydrogen, and the methane from the residue gas stream into the anode comprises introducing the second portion of the residue gas stream into the anode. An embodiment of the invention is one, any or all of prior embodiments in this paragraph up through the second embodiment in this paragraph further comprising injecting oxygen into the second portion of the compressed tail gas stream to form a mixed stream; and passing the mixed stream to a selective oxidation reactor to convert CO to CO₂ before recovering the CO₂ from the tail gas stream. An embodiment of the invention is one, any or all of prior embodiments in this paragraph up through the second embodiment in this paragraph further comprising mixing a portion of a process gas stream with the anode off gas stream, or the cooled anode off gas stream, or the compressed cooled anode gas stream, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for CO₂ capture from a fuel cell off gas stream comprising:
introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon, and the cathode feed stream comprises oxygen, or oxygen and CO₂, the fuel cell generating electricity and producing an anode off gas stream comprising CO₂ and one or more of hydrogen, CO, methane, water, and nitrogen;
cooling the anode off gas stream;
compressing the cooled anode off gas stream in a compressor to form a compressed cooled anode off gas stream;
separating the compressed cooled anode off gas stream in a CO₂ pressure swing adsorption (PSA) system into a residue gas stream comprising CO, hydrogen, and methane and a tail gas stream comprising CO₂;
introducing at least a portion of the CO, the hydrogen, and the methane from the residue gas stream into the anode; and
recovering CO₂ from the tail gas stream as a CO₂ product stream.

2. The process of claim 1 wherein the residue gas stream further comprises nitrogen, and further comprising:
separating the residue gas stream in a second PSA system into a high pressure hydrogen stream comprising the hydrogen, a second tail gas stream comprising the CO, the methane, and a portion of the hydrogen, and optionally a vent gas stream comprising the nitrogen and a portion of the hydrogen; and
wherein introducing at least the portion of the CO, the hydrogen, and the methane from the residue gas stream into the anode comprises introducing the second tail gas stream into the anode.

3. The process of claim 2 wherein the vent gas stream is combusted.

4. The process of claim 1 wherein at least the portion of the residue gas stream is directly introduced into the anode.

5. The process of claim 1 further comprising:
dividing the residue gas into a first portion and a second portion; and
combusting the first portion of the residue gas stream; and
wherein introducing at least the portion of the CO, the hydrogen, and the methane from the residue gas stream into the anode comprises introducing the second portion of the residue gas stream into the anode.

6. The process of claim 1 further comprising:
compressing the tail gas stream forming a compressed tail gas stream;
dividing the compressed tail gas stream into a first portion and a second portion;
recycling the first portion of the compressed tail gas stream to the CO₂ PSA system; and
recovering the CO₂ from the tail gas stream comprises recovering the CO₂ from the second portion of the compressed tail gas stream.

7. The process of claim 6 further comprising:
passing the second portion of the compressed tail gas stream to a compression and dehydration unit to form the CO₂ product stream.

8. The process of claim 6 further comprising:
injecting oxygen into the second portion of the compressed tail gas stream to form a mixed stream; and
passing the mixed stream to a selective oxidation reactor to convert CO to CO₂ before recovering the CO₂ from the tail gas stream.

9. The process of claim 1 wherein the electricity is used to drive the compressor, or another piece of process equipment in the process, or a piece of equipment in a second process, or is exported to an electrical grid, or combinations thereof.

10. The process of claim 1 wherein the fuel cell comprises a solid oxide fuel cell or a carbonate fuel cell or both.

11. The process of claim 1 wherein the anode feed gas stream comprises natural gas.

12. The process of claim 1 further comprising:
mixing a portion of a process gas stream with the anode off gas stream, or the cooled anode off gas stream, or the compressed cooled anode gas stream, or combinations thereof.

13. The process of claim 1 wherein the anode off gas stream has a pressure in a range of 100 to 180 kPa.

14. The process of claim 1 wherein the CO₂ product stream has a purity greater than or equal to 95 mol %.

15. The process of claim 1 wherein the anode off gas stream (on a dry basis) comprises 15 to 45 mol % hydrogen, or 45 to 65 mol % CO₂, or 5 to 15 mol % CO, or combinations thereof.

16. A process for CO₂ capture from a fuel cell off gas stream comprising:
introducing an anode feed gas stream to an anode of a fuel cell and a cathode feed stream to a cathode of the fuel cell, wherein the anode feed gas stream comprises one or more of hydrogen, carbon monoxide, water vapor, and a hydrocarbon, and the cathode feed stream comprises oxygen, or oxygen and CO₂, the fuel cell generating electricity and producing an anode off gas stream comprising CO₂ and one or more of hydrogen, CO, methane, water, and nitrogen, wherein fuel cell comprises a solid oxide fuel cell or a carbonate fuel cell or both;
cooling the anode off gas stream;
compressing the cooled anode off gas stream in a compressor to form a compressed cooled anode off gas stream;
separating the compressed cooled anode off gas stream in a CO₂ pressure swing adsorption (PSA) system into a residue gas stream comprising CO, hydrogen, and methane and a tail gas stream comprising CO₂;
introducing at least a portion of the CO, the hydrogen, and the methane from the residue gas stream into the anode;
compressing the tail gas stream forming a compressed tail gas stream;
dividing the compressed tail gas stream into a first portion and a second portion;
recycling the first portion of the compressed tail gas stream to the CO₂ PSA system; and
recovering the CO₂ from the second portion of the compressed tail gas stream.

17. The process of claim 16 wherein the residue gas stream further comprises nitrogen, and further comprising:
separating the residue gas stream in a second PSA system into a high pressure hydrogen stream comprising the hydrogen, a second tail gas stream comprising the CO, the methane, and a portion of the hydrogen, and optionally a vent gas stream comprising the nitrogen and a portion of the hydrogen; and
wherein introducing at least the portion of the CO, the hydrogen, and the methane from the residue gas stream into the anode comprises introducing the second tail gas stream into the anode.

18. The process of claim 16 further comprising:
dividing the residue gas into a first portion and a second portion; and
combusting the first portion of the residue gas stream; and
wherein introducing at least the portion of the CO, the hydrogen, and the methane from the residue gas stream into the anode comprises introducing the second portion of the residue gas stream into the anode.

19. The process of claim 16 further comprising:
injecting oxygen into the second portion of the compressed tail gas stream to form a mixed stream; and
passing the mixed stream to a selective oxidation reactor to convert CO to CO₂ before recovering the CO₂ from the tail gas stream.

20. The process of claim 16 further comprising:
mixing a portion of a process gas stream with the anode off gas stream, or the cooled anode off gas stream, or the compressed cooled anode gas stream, or combinations thereof.
